(19) United States
(12) Patent Application Publication
(10) Pub. No.: US 2013/0067781 A1
(43) Pub. Date: Mar. 21, 2013

(54) TRANSFERABLE CALENDAR ALERT SYSTEM

(71) Applicant: Mary Beth Martin, Eagan, MN (US)

(72) Inventor: Mary Beth Martin, Eagan, MN (US)

(21) Appl. No.: 13/621,317

(22) Filed: Sep. 17, 2012

Related U.S. Application Data
(60) Provisional application No. 61/535,058, filed on Sep. 15, 2011.

(51) Int. Cl. G09F 3/00; B42D 15/00

(52) U.S. Cl. 40/360; 40/638; 428/343; 428/220; 428/195.1

(57) ABSTRACT

The present disclosure relates to novel and advantageous calendaring systems that include a calendar and a plurality of alert tags. The alert tags are transferable to a second calendar and are also customizable.

### CROSS REFERENCE TO RELATED APPLICATION

This application claims priority to U.S. Provisional Application No. 61/535,058, entitled “Transferable Calendar Alert System,” filed, Sep. 15, 2011, which is hereby incorporated herein in its entirety.

### FIELD OF THE INVENTION

The present disclosure relates to novel and advantageous systems for calendars. More particularly, the present disclosure relates to non-electronic, hard-copy calendar systems that include easy-to-use, customizable, and transferable alerts, in some embodiments.

### BACKGROUND OF THE INVENTION

While the computer age has revolutionized calendaring with the use of PDAs, and digital calendaring systems (for example Microsoft Outlook), many people still use non-electronic calendars, such as wall calendars and/or portable appointment books. Each year the calendar or appointment book must be replaced with a calendar or appointment book for the new year. However, many important dates and/or activities and/or to-dos remain the same from year to year. This means that a user must spend the time to look through the previous year's calendar and transfer all of those dates, activities, to-dos, etc. to the new calendar, which may be tedious and time-consuming. If the transfer is not done, however, the calendar may be of little use. Accordingly, there is a need for a calendar system that allows for the easy transfer of key dates and alerts from one calendar to another.

### BRIEF SUMMARY OF THE INVENTION

The present disclosure relates to novel and advantageous calendaring systems that include a calendar and a plurality of alert tags. The alert tags are transferable to a second calendar and are also customizable.

The present disclosure also relates to an alert tag for use with a non-electronic calendar, the alert tag having a first and second side, the first side having a surface suitable for receiving writing in ink or pencil, and the second side having an adhesive portion suitable for adhering to the surface of the non-electronic calendar, the alert tag being sized such that it is suitable for use with differently-sized non-electronic calendars.

In another embodiment, the present disclosure includes a calendaring system that includes a plurality of alert tags with a first side surface and a second side surface, wherein each alert tag has a customizable first side surface, and each alert tag has adhesive on the second side surface. The system also includes a non-electronic calendar with a plurality of pages that includes a grid showing a month and at least one additional page for receiving the plurality of alert tags, the alert tags being removably coupled to the additional page via the adhesive on the second side surface of the alert tag, and wherein the alert tag may be removed from the additional page and removably coupled to a calendar page that includes a grid showing a month, the alert tag being sized to fit within a square of the grid.

In still another embodiment, the present disclosure includes a method of transferring alerts from one calendar to another calendar. The method includes providing a first non-electronic calendar; providing removeable customizable alert tags, the alert tags being coupleable to the first non-electronic calendar; customizing the alert tags; coupling the customized alert tags to the calendar; providing a second non-electronic calendar; removing the customized alert tags after a desired period; and coupling the customized alert tags to the second non-electronic calendar.

### BRIEF DESCRIPTION OF THE DRAWINGS

While the specification concludes with claims particularly pointing out and distinctly claiming the subject matter that is regarded as forming the various embodiments of the present disclosure, it is believed that the disclosure will be better understood from the following description taken in conjunction with the accompanying Figures, in which:

FIG. 1 shows one page of a calendar system of the present disclosure, according to one embodiment.

FIG. 2 shows alert tags of the present disclosure, according to one embodiment.

FIG. 3 shows alert tags design options according to some embodiments of the present disclosure.

FIG. 4 shows aftermarket packaging of alert tags of the present disclosure, according to one embodiment.

### DETAILED DESCRIPTION

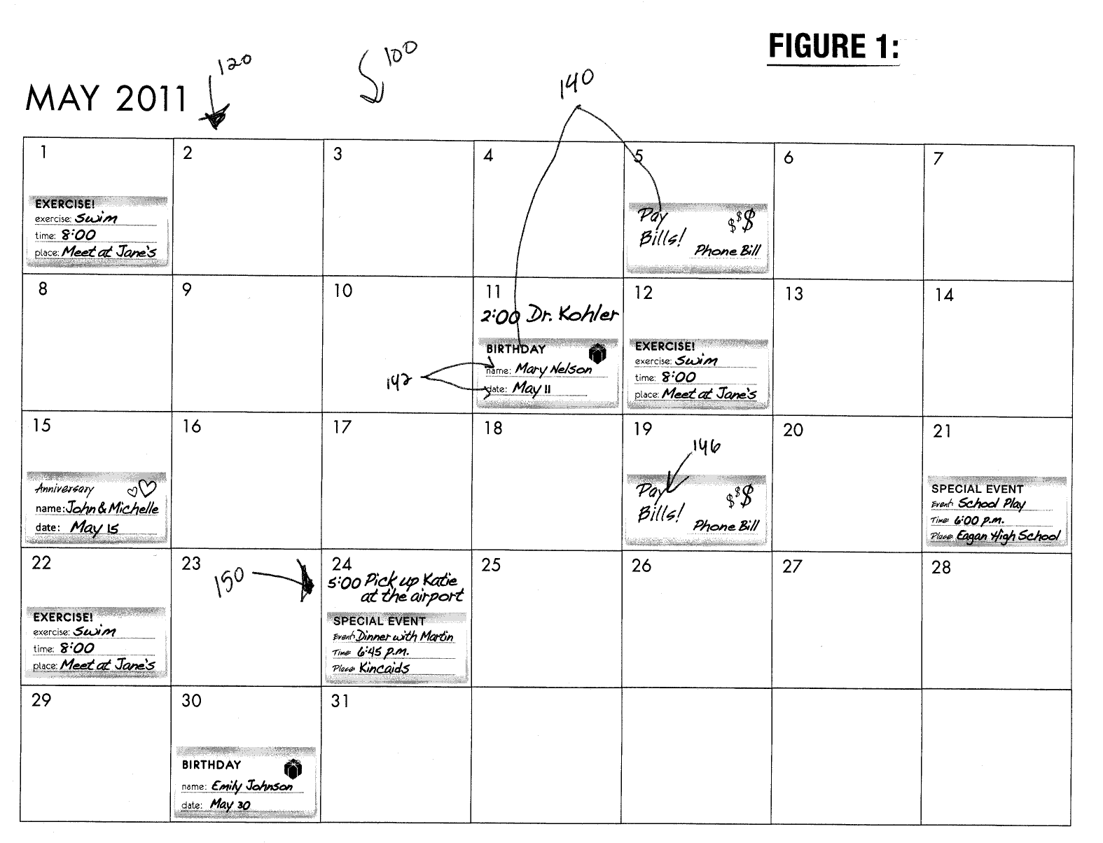

The present disclosure relates to novel and advantageous calendaring systems that may include easy-to-use, customizable, and transferable alert tags. In some embodiments, the system may include a calendar, or appointment book, for example, as well as a plurality of alert tags. As may be seen in FIG. 1, a calendaring system 100 may include a calendar, with multiple pages, wherein a single page may include a month 120, as is well known. The calendaring system 100 may allow the user to write key dates or other information on a removable note 140 that can be transferred at year-end, or any other desired time, to a new calendar, or appointment book, for example. For example, in some embodiments, an alert tag 140 may come pre-printed 142 with alerts such as: Name and Birthday (or Name or Couple and Anniversary Date). In other embodiments, alert tags may be populated by the user with any important information 146.

The technology used to create the alert tags may be the same or similar to that used to create 3M Post-it® Notes, for example. The alert tags 140 may be removed/reused at least 5-10 times/years, in some embodiments. The size of the alert tags 140 may vary based on the calendar size, or appointment book size that is allocated for a date. In some embodiments, the alert tag may be from about ⅓ to about ½ the size of the space available on the calendar for that date, as may be seen in FIG. 1. In some embodiments an alert tag may be about 2 inches×1 inch, while in other embodiments the alert tag may be about 1¼ inch by ⅝ inch. It will be noted, however, that any suitable sizing for the alert tag 140 is within the spirit and scope of the present disclosure. In embodiments where the alert tag does not take up the entire space for a given date, a user may write other information in the remaining space 150.

The alert tags may have a means of adhering to the calendar. For example, in some embodiments, the alert tags may have a strip of adhesive on the back of the alert tag. The amount and placement of adhesive may vary depending on the size of the alert tag. For example, for small sizes, one strip of adhesive may be used, sufficiently sized such that the alert tag may be prevented from becoming dog-eared if the calendar is in a room that could sometimes be windy. For alert tags that may be larger, two or more strips of adhesive may be used. For example, in such embodiments, an alert tag may have two strips of adhesive, one at the top and one at the bottom of the alert tag. In one embodiment, a small corner of an alert tag may have no adhesive, but may have a curved arrow printed in the lower right corner of the alert tag that may indicate how the user should remove the alert tag from the calendar. In some embodiments, the entire back side of an alert tag may have adhesive thereon.

Alert tags may be used for any suitable date reminder, recurring event, to-do, or any other important date information. Some non-limiting examples may include, for example: annual events such as birthdays, anniversaries, first day of school, last day of school, start of spring/holiday break, end of spring/holiday break; other events, such as athletic events (e.g.: Minnesota alert tags could include a design for Vikings, Twins, Wild, or Timberwolves games, for example); reminders for specific tasks, such as “Pay Bills,” for example, which may be moved forward as appropriate, for example if bills are paid on the 1^{st} and the 15^{th} of the month, the alert tag may be posted on the 1^{st} of the month and once the bill is paid, the alert tag may be moved forward to the 15^{th}. In some embodiments, alert tags may also be printed for fitness, grooming (haircut, hair color, waxing, etc.), and health activities. Further, the system may include one or more blank alert tags that may be customized by the user.

In some embodiments, some or all of the days on the calendar may be created with the bottom half of the date a removable alert tag for key tasks. When something on an alert tag does not get completed, the alert tag may be removed and put on a “to do” list, for example.

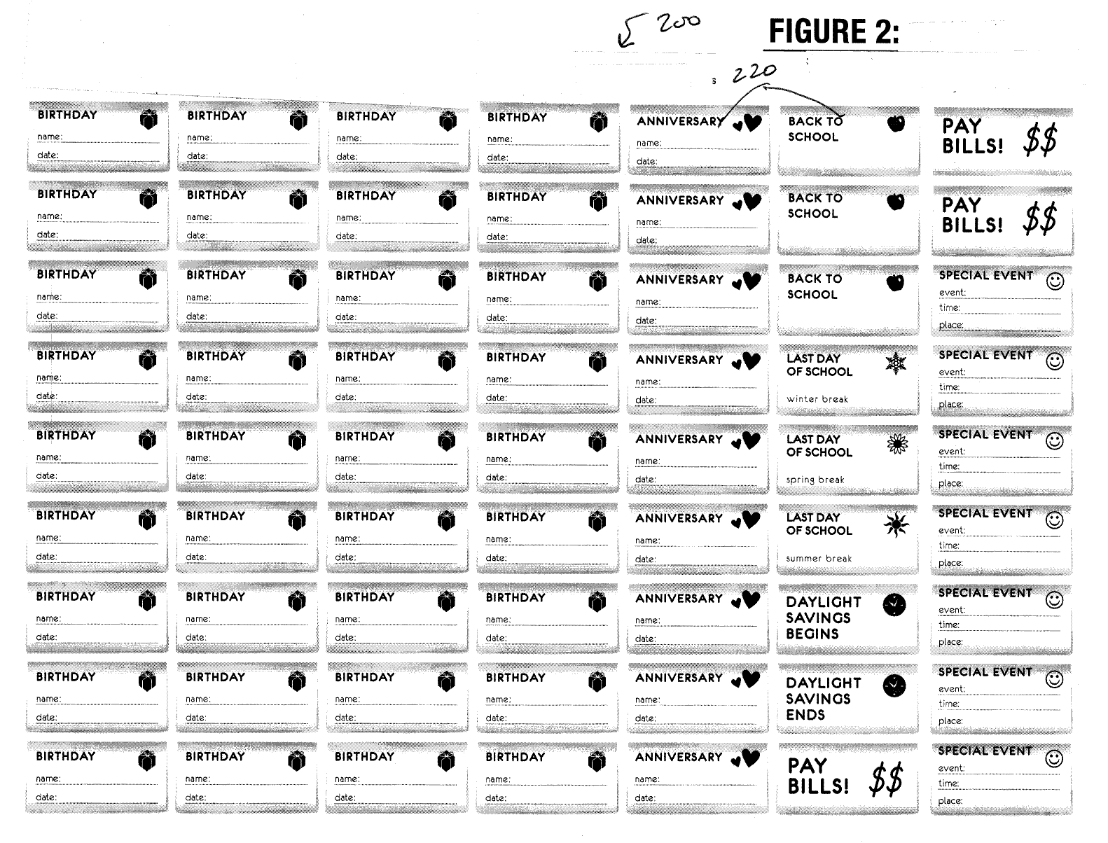

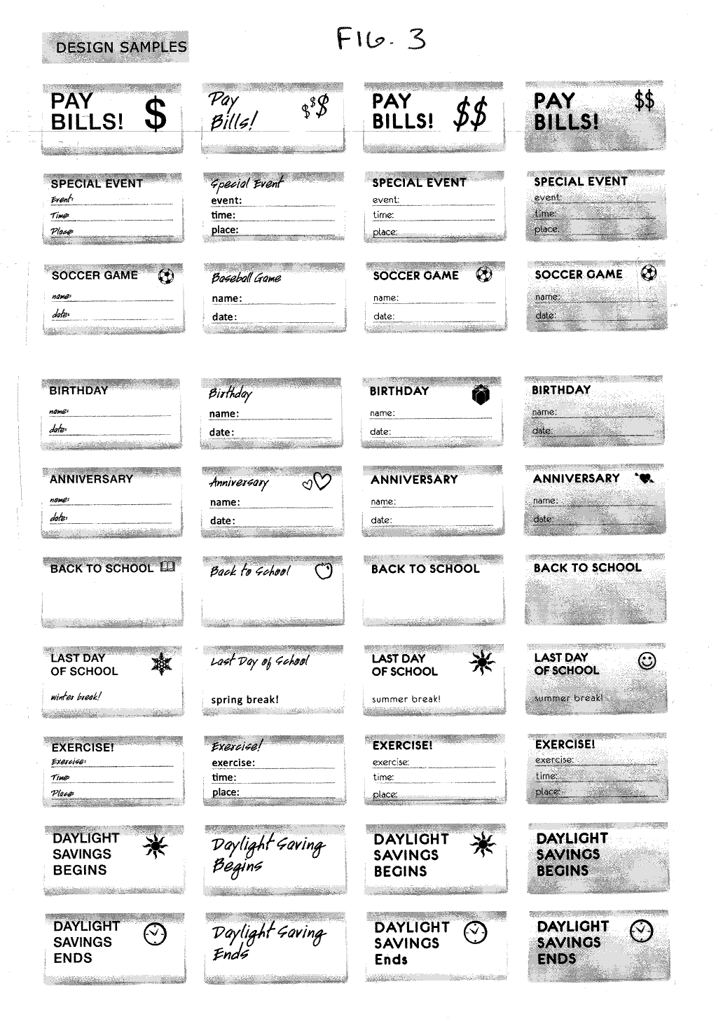

In some embodiments, the calendar may include one or more additional pages 200, for example at the back of the calendar, as may be seen in FIG. 2. In one embodiment, some or all of the pages may be used as a “holding page(s)” to place the carry-over alert tags until the new calendar may be purchased. This could be a tear-off page that could be kept separately if there's a time lag between throwing out the old calendar and reposting the Calendar Minders in the new one. An additional page 200 may also provide one or more alert tags 220 that the user may customize and use as necessary throughout the calendar year. The alert tags 220 may be included in any configuration, including providing several different types of alert tags, that may come in one or more different sizes, and/or colors for example. Examples of different possible embodiments for alert tags is provided in FIG. 3, though it will be understood that still other options are possible and within the spirit and scope of the present disclosure.

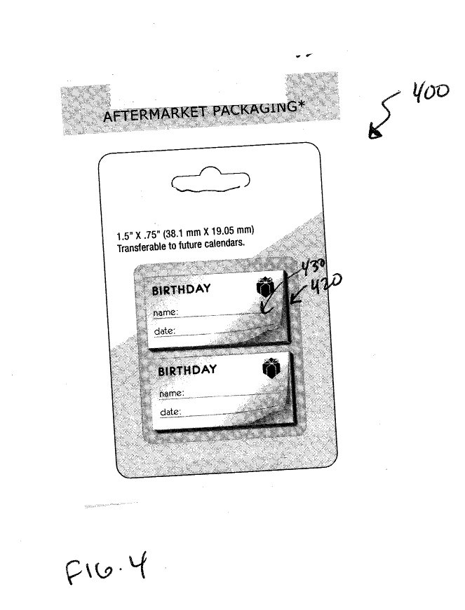

In one embodiment, a calendaring system may include the calendar or appointment book and a plurality of alert tags. For example, a small pad 420 of alert tags 430 may be included, such as those shown in FIG. 4. Or, in other embodiments, the final or first sheet of the calendar could be a sheet of peel-off alert tags, for example.

In another embodiment, alert tags may be sold as an aftermarket product. For example, the alert tags may be packaged and sold separately from the calendar, as shown in FIG. 4. The alert tags may be sold in physical stores, in catalogs, and/or online, in some embodiments.

The embodiments described herein and the various features and advantages of the embodiments are explained more fully with reference to the non-limiting embodiments that are illustrated in the accompanying drawings and detailed herein. Descriptions of well-known components and processes and manufacturing techniques are omitted so as to not unnecessarily obscure the embodiments herein. The examples used herein are intended merely to facilitate an understanding of ways in which the embodiments disclosed herein may be practiced and to further enable those of skill in the art to practice the embodiments described. Accordingly, the examples provided should not be construed as limiting the scope of the claimed invention.

What is claimed is:

1. An alert tag for use with a non-electronic calendar, the alert tag having a first and second side, the first side having a surface suitable for receiving writing in ink or pencil, and the second side having an adhesive portion suitable for adhering to the surface of the non-electronic calendar, the alert tag being sized such that it is suitable for use with differently-sized non-electronic calendars.

2. The alert tag of claim 1, wherein the alert tag is 2 inches×1 inch in size.

3. The alert tag of claim 2, wherein the alert tag is 1% inch×⅝ inch in size.

4. The alert tag of claim 3, wherein the first side surface includes pre-printed alert cues related to birthdays.

5. The alert tag of claim 4, wherein the pre-printed alert cues related to birthdays include blank lines for a user to provide indicia related to birthdays.

6. The alert tag of claim 5, wherein the first side surface further includes an icon related to birthdays.

7. The alert tag of claim 3, wherein the first side surface includes pre-printed alert cues related to anniversaries.

8. The alert tag of claim 7, wherein the pre-printed alert cues related to anniversaries include blank lines for a user to provide indicia related to anniversaries.

9. The alert tag of claim 8, wherein the first side surface further includes an icon related to anniversaries.

10. The alert tag of claim 3, wherein the first side surface includes pre-printed alert cues related to sporting events.

11. The alert tag of claim 3, wherein the first side surface includes pre-printed alert cues related to grooming.

12. The alert tag of claim 3, wherein the first side surface includes pre-printed alert cues related to holidays.

13. The alert tag of claim 3, wherein the alert tag is one of a plurality of alert tags adhered together into an alert tag pad.

14. The alert tag pad of claim 13, wherein each of the plurality of alert tags includes the same pre-printed alert cues on the first side surface.

15. The alert tag of claim 13, wherein the plurality of alert tags include a portion of the alert tags with a first pre-printed alert cue on the first side surface, and the remaining portion of the plurality of alert tags include a second pre-printed alert cue on the first side surface.

16. The alert tag of claim 15, wherein the first pre-printed alert cue is related to birthdays, and the second pre-printed alert cue is related to anniversaries.

17. The alert tag of claim 14, wherein the plurality of alert tags are yellow.

18. The alert tag of claim 14, wherein the plurality of alert tags are packaged for sale in a store.

19. A calendaring system comprising:
a plurality of alert tags with a first side surface and a second side surface, wherein each alert tag has a customizable first side surface, and each alert tag has adhesive on the second side surface; and
a non-electronic calendar with a plurality of pages that includes a grid showing a month and at least one additional page for receiving the plurality of alert tags, the alert tags being removably coupled to the additional page via the adhesive on the second side surface of the alert tag, and wherein the alert tag may be removed from the additional page and removably coupled to a calendar page that includes a grid showing a month, the alert tag being sized to fit within a square of the grid.

20. A method of transferring alerts from one calendar to another calendar, the method including:
providing a first non-electronic calendar;
providing removeable customizable alert tags, the alert tags being coupleable to the first non-electronic calendar;
customizing the alert tags;
coupling the customized alert tags to the calendar;
providing a second non-electronic calendar;
removing the customized alert tags after a desired period; and
coupling the customized alert tags to the second non-electronic calendar.
